(19) United States
(12) Patent Application Publication
(10) Pub. No.: US 2015/0124239 A1
(43) Pub. Date: May 7, 2015

(54) SYSTEM AND METHOD FOR MEASURING THE POSITION OF THE CONTACT WIRE OF AN OVERHEAD POWER LINE RELATIVE TO A RAILWAY TRACK

(71) Applicant: ROV DEVELOPPEMENT, LA CIOTAT (FR)

(72) Inventor: Edmond Briand, La Ciotat (FR)

(21) Appl. No.: 14/400,114

(22) PCT Filed: May 6, 2013
(86) PCT No.: PCT/FR2013/051014

§ 371 Date: Nov. 10, 2014

(30) Foreign Application Priority Data
May 11, 2012 (FR) 1254318

(51) Int. Cl. G01C 5/00; G01C 1/00

(52) U.S. Cl. CPC G01C 5/00; G01C 1/00
USPC 356/4.08; 356/139.06

(57) ABSTRACT

The invention relates to a system for measuring the position of the contact wire of an overhead power line, comprising a first measurement means including a vertical rangefinder capable of measuring the height of the contact wire and a second measurement means capable of measuring the offset of the contact wire. The system also comprises at least one first inclinometer that enables the inclination of the mounting of the system positioned on the rails to be measured, and a camera pointing upward and capable of capturing the image of the contact wire, and the second measurement means comprises a second inclinometer secured to the laser rangefinder, which is mounted on a motor-driven lateral-inclination pivot, and which is capable of measuring the angle of the beam thereof relative to the vertical when aimed at the contact wire.

The purpose of this invention is a system and method for measuring the position of the contact wire of a power supply catenary with respect to a railway track comprising rails located under said catenary.

A known method for supplying power to electric motor trains is by means of an overhead power line system suspended above the track between supporting posts or arched catenary support or other carrying structures spaced along the track. A typical catenary system, hereinafter simply designated as catenary, comprises a contact wire suspended to suspension elements of a support cable, which suspension elements or structure, consisting of braces and connecting arms, are secured to supporting posts. The contact wire is kept at a high electric potential and supplies electric power to the train. For that, it has a telescopic structure for collecting power, called pantograph, mounted on its roof. The pantograph includes transversally to the direction of the track a contact surface that rests on the contact wire of the catenary in a basically continuous manner while the train is traveling along the track.

The support cable forms a curve in the vertical plane, which looks like a portion of a parabola, between the supporting posts under gravity's pull, but the contact wire is kept parallel to the track by varying the length of the lines that support and link the suspended contact wire to the support cable.

The position of the catenary above the track must be carefully checked and kept in a predetermined position to ensure continuous contact between the pantograph and the contact wire to guarantee, without uncontrolled interruption, the electric power supply to the train. Not only must there be continuous contact, but the contact point on the pantograph must move and vary permanently over the length of the transversal surface of the pantograph while the train is moving along the track to avoid otherwise wear due to excessive friction on a portion only of the pantograph. Consequently, the vertical and horizontal positions of the contact wire with respect to the pantograph are important for the efficient operation of the train.

Controlling the vertical position of the pantograph permits maintaining appropriate contact pressure but:
If the wire is too low, this contact pressure can become too great and generate excessive friction between the wire and the pantograph; in this case, the contact wire also risks to hook a part of the train under the pantograph and this may lead to the catenary dropping down, and consequently, to electrocute the passengers or the spectators,
And if the contact wire is too high, the pantograph can lose contact and, denying the train of its power, stop it unexpectedly out on the track,
And if the contact is intermittent, the train shall be exposed to sudden power bursts and drops,
Which will produce an uncomfortable ride and may damage the train equipment and apparatus.

The horizontal position of the catenary relative to the pantograph must also be checked and maintained to avoid that the contract wire may, on the one hand, be positioned laterally on the left or on the right, beyond the length of the pantograph, and on the other hand, as shown before, in permanent contact with a single point of the pantograph, because if this were the case, the pantograph would rapidly be cut into two by reason of the continuous rubbing at this point with the contact wire. To avoid this problem, it has been determined to position the catenary above the track according to a pattern, in a horizontal plane, in zig-zag with respect to the median plane of the track. Consequently, the contact point between the wire and the pantograph varies constantly over the length of the pantograph while the train is running on the track, and the entire contact surface of the pantograph is exposed to the same wear and tear. The zig-zag pattern must of course be carefully defined and checked to ensure also that the contact wire remains laterally within the limits of the length of the pantograph.

Maintaining the vertical and horizontal position of the catenary relative to the pantograph according to well-defined parameters, to comply with the conditions stated above, consequently requires measuring and controlling these parameters of the position of the catenary relative to reference points at numerous locations predetermined along the track, not only during installation but also subsequently and regularly during operation. By convention, the middle of the track is often taken as reference point,

this is at the intersection of the median plane passing through its central axis and of the tangent plane at the top curve of the section of the rails, also called track plane, at each predetermined location along the track where measurements must be made: consequently, these measurements are at least the height and the offset of the contact wire.

Height in this context involves as such the perpendicular distance between a parallel plane and a track plane and passes through the abovementioned reference point and the contact wire of the catenary at the predetermined location along the track. Consequently, for a horizontal track, height will simply be the vertical distance between the reference point and the contact wire but if the track is on a slope, as in curves, height will not be the vertical distance but will be measured at an angle corresponding to the angle of the slope. The height must always be measured perpendicularly to the plane of the track irrespective of the angle of the track with the horizontal.

Within the framework of this invention, the offset refers to the lateral offset of the catenary with respect to the centerline of the track measured perpendicularly to the height. For instance, on a horizontal track, the offset is the horizontal distance of the contact wire with respect to the vertical median plane passing through the centerline of the track. Height and offset are always measured according to two perpendicular directions, and a rectangular triangle is made up of height, offset and distance, the so-called aiming distance, between the reference point and the contact wire. Height and offset are thus linked to this aiming distance in a similar way on the sides of a right-angled triangle with respect to

the hypotenuse by the trigonometric functions of cosine and sine respectively of the angle that makes the hypotenuse, this being the sight distance with the side corresponding to height: these geometric considerations enable calculating one of the sides and consequently a desired measuring value when the hypotenuse and one of its adjacent angles are known.

In spite of the importance of these measurements of height and offset of the contact wire for maintaining the catenary and the efficiency of the electric powered trains, to date there is really no efficient device or method, that is practical, reliable and accurate to make such measurements. In fact, two types of methods or processes to make such measurements exist today. A first method consists of measuring the height and the offset at a predetermined location along the railway track with manually implemented means with a pole that is electrically insulated and a mirror and index system to measure the offset by image alignment. To measure the height of the contact wire, the pole is held vertically by an operator positioned under the catenary and it is deployed upward, by maintaining its bottom part on a ruler placed on the track until its top part makes contact with the contact wire; the pole is graduated, the distance to the contact wire is measured by reading the corresponding graduations.

Without developing here the offset measuring method by a mirror and index system, several inconveniences of these manual methods and means appear immediately, such as:
Safety of the people when handling poles that make contact with wires carrying in general 13,000 volt; consequently, such measurements cannot take place when it rains or it snows due to the risk of electrocution of the operators.
Measurements of the height can be limited by the length of the poles and strong wind can prevent making measurements.
Two operators are required, one to hold and handle the equipment, the other one to take and record the measurements.
Any manual method is subject to human error. Data collected must later be computed by hand or input in a computer, which generates another risk of human error. And for measuring the offset with a mirror and index system, it may be difficult to see what wire is being measured if there are several wires above the track and there may be an error by aligning in the mirror, the image of another wire, other than the one desired, with the index.
These manual methods for measuring do not permit either to make other measurements of the track and of the catenary, like the slope angle or the separation of the rails, while these are useful to know to calculate accurately the height and offset of the contact wire: indeed, the latter must be measured or calculated with respect to the centerline of the track, for which the position depends on the separation of the rails, and the height must be measured or calculated in a perpendicular plane with respect to the track plane, and for which it is necessary to have a good idea of the track slope.

As such, for several years now, a second type of methods has been developed that uses radar type measuring means or most recently laser measuring means; they are situated on supports placed on the rails or mounted on mobile carts on the track, and certain of which were the object of patent application filings: for instance, one can mention the device and the method described in U.S. Pat. No. 5,930,904 of Mr. Charles Mualem filed on Jun. 17, 1997 and which shows a device comprising a range finder to measure the height of the catenary, which is installed either on a graduated horizontal ruler (the range finder is always pointed upward perpendicular to this ruler), or on an angular protractor which permits measuring the offset of the contact wire by a visual measurement of the movement of the sensor manually either by translation or by rotation, which does not provide great accuracy; this system and method may then be subject to errors and do not offer the possibility of measuring the slope and/or the separation of the tracks and in addition, comprise the inaccuracies mentioned with the manual systems about this particular subject.

Another patent application ES 2367067 filed by the Telice Telefonos company on Nov. 10, 2008 describes a device to measure among other the height and the offset of the contact wire with respect to the median point of the rolling surface but also the rail separation, thanks to a subsystem of horizontal movement consisting of a slide installed perpendicularly to the track and equipped with a detection means of the internal face of each rail, and a measuring means of the distance traveled by the slide. This slide is also equipped with a device provided with a laser ray transmitter for positioning the catenary and a vertical measurement system to calculate the distance between the catenary and the track: this device is the most developed of the equipment or devices known today but on the one hand, its design requires a wider width than that of the gage of the rolling stock normally used on the track and on the other hand, its implementation does not guarantee a good accuracy of all of the measurements; the latter does not include the sloping measurement either; in addition, little information is given regarding the calculation of the measurement of the height and offset, while as was already shown, the latter depends among other from the slope which is not measured and the variation of the separation of the rails can modify the reference of the centerline of the track, relative to which the offset must be measured.

Consequently, the problem at hand is to have available a measurement system and an implementation method that permits:
On the one hand, rapid measurements and very great precision or accuracy,
On the other hand, measurements at the same of time of the height and offset but also of the slope of the track which is an essential data for checking the good position of the catenary with respect to its axis or center, and in addition and preferably, of the separation of the rails which, besides the fact that it is a useful data in itself, permits improving the measurement of the offset and obtaining the best accuracy,
Without having the inconveniences of the present-day devices, such as mechanical parts in movement of translation and/or falling outside the normal gauge of the track, no interruption of the electric power of the catenary, risks of calculation errors and/or a lack of data to obtain the most accurate measurement results
and a very quick installation, little or no maintenance, suitable to be secured to a rolling stock or a ruler placed on the track, requiring the presence of a single operator and with the latter not intervening directly while the measurements are made but only in the preparation and positioning of the sensors to avoid, in particular and as a maximum, the risks of human errors and to increase the accuracy and speed of the measurements.

A solution to the problem is a system measuring the position of the contact wire of a power supply catenary relative to a railway track. It includes as is well-known a first measurement means that includes a vertical range finder capable of measuring the height of the contact wire with respect to the railway track and of second means of measurements capable of measuring the offset of the contact wire with respect to the vertical median plane of said rails. All of these measuring means are situated on a support placed on the rails. According to the invention, the system also includes at least one first inclinometer enabling the measurement of the inclination of the system support with respect to the horizontal and a camera pointed upward in the same direction as the vertical axis of the track and capable of capturing the image of the contact wire and the second measurement means include a second inclinometer secured in one piece to the laser range finder mounted on a motor-driven lateral inclination pivot, and capable of measuring the angle of its beam with respect to the vertical when it is aimed at the contact wire.

Another solution to the problem at hand is a measuring method for the position of the contact wire of a power supply catenary, relative to a railway track comprising two rails situated under said catenary and so that:
One displays the image provided by a camera pointed upward from a support platform placed on the track and in the same direction as the latter's vertical median axis, on a screen and one clicks on the contact wire displayed on the screen,
One moves the sight of a vertical laser range fighter, situated in the median plane of the same platform, by motor-driven rotation of the latter around a support pivot, in a plane perpendicular to the median plane, towards and up to the position of the corresponding point that was clicked on the screen,
One measures the distance of the contact wire with said range finder, and one calculates the latter's angle with the vertical by subtracting the values recorded by a first inclinometer measuring horizontally and a second inclinometer measuring the rotation of the range finder,
One deducts from this the height of the wire relative to the track plane, the offset of the contact wire relative to the vertical median plane of the latter and its slope angle relative to horizontal.

In a preferential method of embodiment, all of the measurement means of the system according to the invention are integrated in a measuring station for which the housing is secured to a support capable of being placed on top of the rails and wedged on one of its sides against the inside of one of its rails, the other side is placed freely on the other rail,

and includes a removable sight aimed at coming into contact vertically against the inside of the other rail. This system includes at least a second range finder with a lateral aim towards this sight.

In another method of embodiment, all of the measuring means of the system according to the invention are integrated in a measuring station for which the housing is secured on a mobile support provided with wheels capable of moving about on the rails. This system includes at least two lateral aim range finders each towards a rail.

The result is a new system and method for measuring the position of the contact wire of a catenary relative to the railway track that it feeds with power, as well as of the slope and separation of the rails that in addition permit a better measurement of said contact wire position. Said system and method do not have the inconveniences of the present systems and methods described above and meet all of the objectives of the problem at hand. Indeed, there is no mechanical part that is moving in translation and/or outside the normal track gauge. Measurements are made without interrupting the power supply of the catenary; installation of the system is very quick and it does not need much maintenance or none at all. The whole system can be mounted on a ruler placed on the track but also on a rolling stock and permits rapid measurements practically without interruption along the track. Only one operator is required and he does not intervene directly while the measurements are being made, only during the preparation of the equipment and the positioning of the sensors such as clicking on the image of the contact wire in the field of vision of the camera; then to

position automatically the aim of the laser range finder on this wire and even more, this click could be made by an image analysis that would identify it without the operator's intervention; consequently, human error is nearly eliminated. There is no reporting and all of the measurements are made automatically and rapidly, in about ten seconds; then, they are processed by a microprocessor which by known calculations provide all the results of desired distances and angles such as the height of the contact wire and its offset according to the definitions given in the introduction. The slope angle of the track and the distance between the rails, all these measurements and data are stored in a memory and can be displayed according to any desired method of presentation on any computer screen.

The advantages mentioned above for this new measuring system and method show the interest and the description below and the figures attached show two examples of embodiment. However, other methods of embodiment are possible within the scope of this invention.

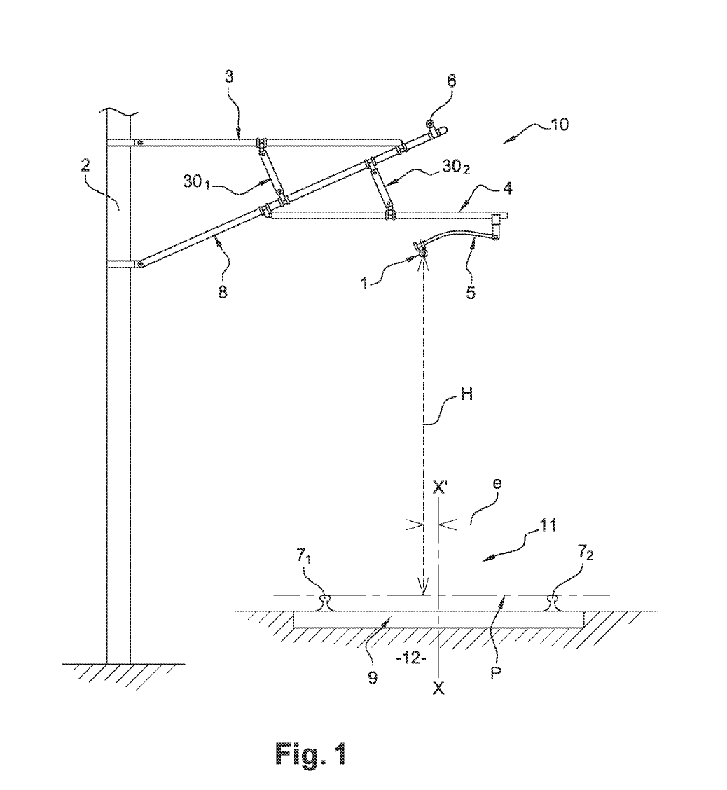

FIG. 1 is a sectional diagram of a typical railway track 11, perpendicular to its direction and to the median plane XX′ of rails 7 that make it up, shown here by sleepers 9 and a ballast 12. Above said track 11, there is a catenary assembly 10 secured onto a lateral supporting post 2 and shown here according to a typical example of embodiment.

This catenary 10 structure includes a brace 8 forming a main arm, a second arm 3 for a brace supporting arm 8, and a third arm 4 that forms an anti-swaying arm

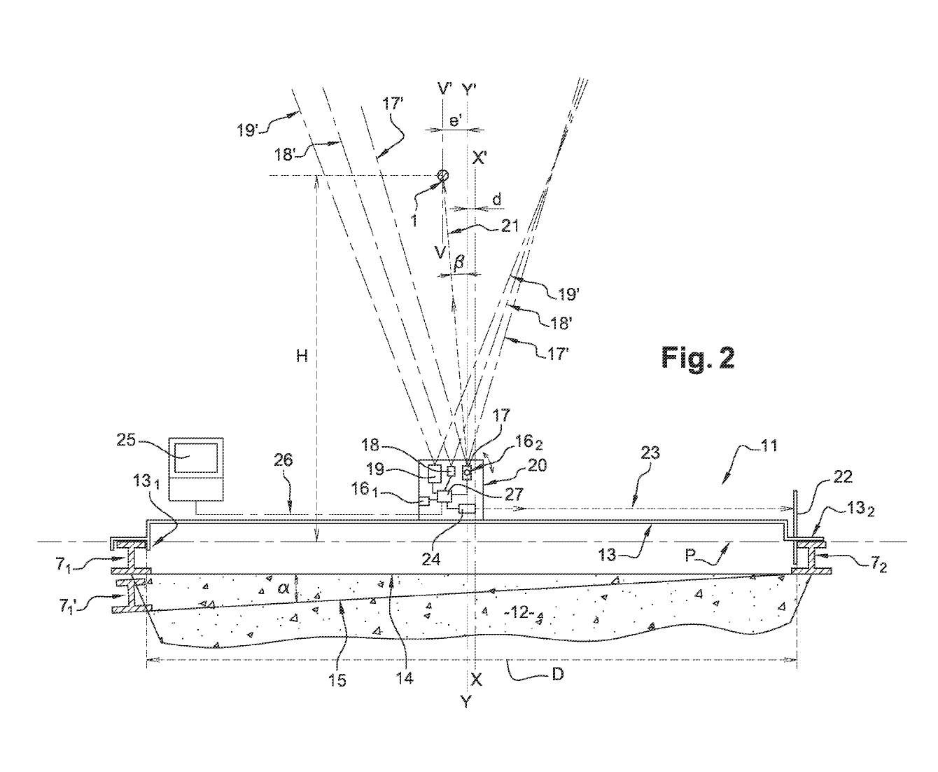

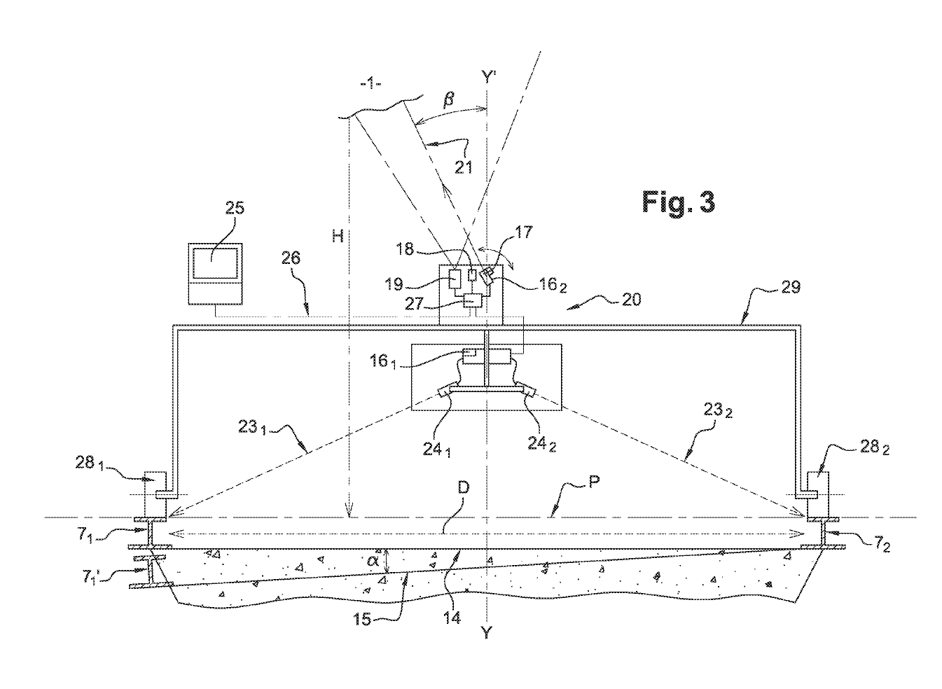

and is adjustably connected to brace 8. These three arms can be tied two by two by spacers 30₁, 30₂; this anti-swaying arm 4 ends in a steady arm 5 linked to and supporting contact wire 1, while the main arm that forms brace 8 supports the supporting cable 6, connected to contact wire 1 between two posts 2 by lines not shown here, and as already described in the introduction, to keep the contact wire 1 parallel to the track. These suspension elements forming the catenary structure and the catenary itself, are not shown on FIGS. 2 and 3 while, needless to say, they are present above the railway track in question.

FIG. 2 is a partial sectional diagram of a railway track, perpendicularly to its direction, on which a first example of embodiment is shown of a measurement system according to this invention.

FIG. 3 is also a partial diagram of a railway track, perpendicularly to its direction, on which a first example of embodiment is shown of a measurement system according to this invention mounted on a mobile platform.

The measurement systems as schematically shown on these figures, of the position of contact wire 1 of a power supply catenary relative to a railway track 11, include as has been shown already in the known equipment today, a first means of measurement including a vertical range finder 17 capable of measuring height H of contact wire 1 relative to rails 7 of the railway track and second measuring means capable of measuring offset “e” of the contact wire relative to vertical XX′ median plane of said rails; all of these measuring means are situated on a support 13, 29 placed on rails 7.

According to the invention, the system also includes at least a first inclinometer 16₁ that enables measuring inclination “α” of support 13, 29 of the system relative to horizontal 14 and consequently to provide directly this angle which is the one for slope 15 of track 11, as shown with rail 7₁′ located under rail 7₁ of a track without slope for which plane P is horizontal.

A camera 19 is pointed upward in the same direction as axis XX′ of the track and is capable of capturing in its field of vision 19′ the image of contact wire 1; and the second means of measurements include a second inclinometer 16₂ that forms one unit with laser range finder 17 mounted on a motor-drive lateral inclination pivot in a plane perpendicular to said median plane XX′ and capable of measure angle “β” of beam 21 of the latter relative to the vertical when the support is horizontal and when it aims at contact wire 1 thanks precisely to the image captured by the camera: this enables the operator to control this aim automatically by simply clicking on the displayed image of the wire on a screen 25 for instance of a portable computer hooked up to measuring station 20 in which are incorporated all of the measuring means of the system according to the invention. For that, scanning limits 17′ of laser beam 21 are located inside the field of vision 19′ of the camera at least up to the maximum theoretical height of contact wire 1 to be measured.

Knowing now the exact dimensions of station 20, its support 13, 29 and the location of range finder 17 relative to plane P, the distance of contact wire 1, inclination angle “β” of range finder 17 and that of slope “a” of track 11, the system can compute automatically by a simple software that an expert in the field can write and enter in a microprocessor 27 of the system or of an external computer 25, height “H” of contact wire 1 and this exactly according to the definition given in the introduction.

To obtain a better image taken by camera 19, the system includes on the housing of measuring station 20, lighting 18 directed upward and for which light cone 18′ covers the largest part of the field of vision 19′ of camera 19.

According to the method of embodiment shown in FIG. 2, housing 20 of this measuring station is secured, here on top, to a support 13 such as a ruler, capable of being position on top of rails 7 and wedged by a stop 13₁ on one of its sides, here on the left of the figure, against the inside of one of these rails 7₁; the other side 13₂ of this support 13 freely placed on the other rail 7₂ includes a removable sight 22 that can be positioned on the side of support ruler 13, here behind the plane of the figure, and to come into contact vertically against the inside of this other rail 7₂; this system includes at least a second range finder 24 with a lateral aim 23 towards this sight 22.

According to the method of embodiment shown on FIG. 3, housing 20 of the measuring station is secured, here on top, on a mobile support 29 provided with wheels 28 which can move about on rails 7. This system includes at least two range finders 24₁, 24₂ with lateral aim 23₁, 23₂ each towards a rail 7₁, 7₂ and arranged in a second housing, under the platform of mobile support 29 to enable a clear aim of the range finders;

This second housing can include first inclinometer 16₁; or a third inclinometer as an option if the first one is in housing 20, enabling to measure inclination “α” of support 29 relative to horizontal 14.

In both methods of embodiment, said system with its support 13, 29 and all of the measuring means forms a device that can be integrated and transported, and an outside gauge at most equal to that of the rolling stock traveling normally on railway track 11.

In addition to height “H” of wire 1 relative to rail 7, microprocessor 27 of the system or an outside computer 25, hooked up to the assembly of measuring means, can compute automatically through a simple software that can be written by an expert in the field and entered in microprocessor 27 or computer 25, is capable of computing from the measurements provided by the measurement means, offset “e” of contact wire 1 relative to median plane XX′ of said rails 7, the inside separation D of rails 7 and slope angle “α” of the track.

Such a system permits the implementation of a method for measuring the position of contact wire 1 of catenary 5,6 related to railway track 11 so that:
One displays the image provided by camera 19, pointed upward from platform 13, 29 situated on track 11 and in the same direction as vertical median axis XX′ on screen 25 and one clicks on contact wire 1 shown on the screen.
One moves sight 21 of vertical laser range finder 17, situated in the median plane YY′ of platform 13, 29 by motor-driven rotation of the latter around a support pivot, towards and up to the position of the corresponding point that one clicked on the screen
One measures the distance of contact wire 1 with said range finder 17 and one calculates its “β” angle with the vertical by subtracting values observed by the first inclinometer 16₁ which measures horizontally and the second inclinometer 16₂ which measures the rotation of range finder 17
Through the computations already made before, one deduces height “H” of wire 1 relative to plane P of the track, offset “e” of contact wire 1 relative to vertical median plane xx′) of the latter and its “α” slope angle relative to horizontal.

In addition, according to the method of embodiment of FIG. 2:
One locates a surveying pole or sight 22 vertically and against the inside of one of rails 7₂ and one measures its distance with a second range finder 24 positioned at a known distance of the other rail 7₁, with lateral aim 23 and secured to platform 13 that supports all of the measuring means; said platform can be move from one measuring point to another and supported on top of both rails 7₁, 7₂.
By computations already mentioned before, one deduces the values of the inside separation

“D” of rails 7₁, 7₂ and of the position gap of vertical median planes YY′ of the platform and XX′ of the track and one corrects consequently et possibly the values of height “H” and offset “e” of contact wire 1,

And according to the method of embodiment of FIG. 3:
One situates on platform 29, which supports all of the measuring means, two range finders 24₁ and 24₂ with side
aim 23₁, 23₂, each towards one rail 7₁, 7₂ and according to a known inclination relative to the platform plane; this platform 29 is mobile and is equipped with wheels 28 capable of moving about on rails 7,
One measures the distance of each of rails 7 with range finder 24 which aims at it and one deduces, by computation already mentioned before, the values of the inside distances “D” of rails 7₁, 7₂ and the position distance of the vertical median planes YY′ of the platform and XX′ of track 11 and one corrects consequently and possibly the values of height “H” and offset “e” of contact wire 1.

1. A system for measuring the position of a contact wire of a power supply catenary relative to a railway track comprising a first measurement means comprising a vertical range finder capable of measuring a height of the contact wire relative to rails of the railway track, and second measuring means capable of measuring an offset of the contract wire relative to a vertical median plane of said rails and comprising an inclinometer secured to the vertical range finder mounted on a lateral inclination pivot and capable of measuring its beam angle when it points to the contact wire; all of these measuring means are arranged on a support placed on the rails, wherein the system further comprises at least another inclinometer that permits measuring inclinations of the system support relative to the horizontal and a camera pointed upward in the same direction as the axis of the track and capable of capturing the image of the contact wire, and wherein the inclination pivot of the vertical range finder is motor-driven.

2. The measuring system according to claim 1 wherein all of the means of measurement of the system are integrated in a measuring station for which the housing is secured to a support that can be placed on top of the rails and wedged on one of its sides against the inside of one of these rails, with the other side being freely placed on the other rail, and comprising a removable surveying pole or sight aimed to enter into contact vertically against the inside of this other rail, said system comprises at least a second range finder with lateral aim towards a surveying pole or sight.

3. The measuring system according to claim 1 wherein all of the measurement means of the system are part of a measurement station for which the housing is secured to a mobile support equipped with wheels capable of moving about on the rails, said system comprises at least two range finders with lateral aim each towards a rail.

4. The measuring system according to claim 2 wherein said system with its support and all of the measuring means forms an integrated and transportable unit and with an outside gauge at most equal to that of the rolling stock running normally on the railway track.

5. The measuring system according to claim 1 wherein it includes a microprocessor hooked up to all of the measuring means and capable of computing, on the basis of the measurements provided by the latter, at least the height of the wire relative to the rail, the offset of the contact wire relative to the median plane of said rails, and the slope angle of the track.

6. The measuring system according to claim 5, wherein the microprocessor is capable of computing the inside distance of the rails.

7. The measuring system according to claim 1 further comprising lighting pointing upward to cover the field of vision of the camera.

8. A method for measuring a position of a contact wire of a power supply catenary relative to a railway track comprising two rails situated under said catenary comprising:
displaying the image provided by a camera, pointed upward from a platform situated on the track and in the same direction as its vertical median axis, on a screen and clicking on the contact wire displayed on the screen;
moving the aim of a vertical laser range finder, situated in the median plane of the same platform, by motor-driven rotation around a support pivot, in a plane perpendicular to said median plane towards and up to the position of the corresponding point that was clicked on the screen;
measuring the distance of the contact wire with said vertical range finder and calculating the angle of the latter with the vertical by subtracting the values recorded by a first inclinometer for measuring horizontally and a second inclinometer for measuring the vertical range finder rotation; and
deducting the height of the contact wire relative to the plane of the track, the offset of the contact wire relative to its vertical median plane and its slope angle relative to the horizontal.

9. The measuring method according to claim 8 further comprising:
placing a surveying pole or sight vertically and against the inside of one of the rails and measuring its distance with a second range finder with lateral aim and secured to the platform supporting all of the measuring means, said platform can be moved from one measuring point to another and positioned at a known distance of the other rail and situated on both rails; and
deducting the value of the inside distance of the rails and the difference of position of the vertical median planes of the platform and of the track and one corrects consequently and possibly the values of height and offset of the wire.

10. The measuring method according to claim 8 further comprising:
placing on the platform that supports all of the measuring means, two range finders with a lateral aim each towards a rail and according to a known inclination relative to the plane of the platform, said platform is mobile and equipped with wheels and can be moved on the rails, and
measuring the distance of each of the rails with the range finder that aims at it and one deducts the value of the inside distance of the rails and the difference of position of the vertical median planes of the platform and of the track, one corrects consequently and possibly the values of height and offset of the wire.
